(19) United States
(12) Patent Application Publication
(10) Pub. No.: US 2019/0389776 A1
(43) Pub. Date: Dec. 26, 2019

(54) LASER ASSISTED FLASH SINTERING

(71) Applicant: The Government of the United States of America, as represented by the Secretary of the Navy, Arlington, VA (US)

(72) Inventors: Guillermo R. Villalobos, Springfield, VA (US); Rafael R. Gattass, Washington, DC (US); Michael Hunt, Alexandria, VA (US); Shyam S. Bayya, Ashburn, VA (US); Bryan Sadowski, Falls Church, VA (US); Robert Miklos, La Plata, MD (US); Frederic H. Kung, Alexandria, VA (US); Woohong Kim, Lorton, VA (US); L. Brandon Shaw, Woodbridge, VA (US); Jasbinder S. Sanghera, Ashburn, VA (US); Antti Makinen, Alexandria, VA (US)

(21) Appl. No.: 16/448,307

(22) Filed: Jun. 21, 2019

Related U.S. Application Data
(63) Continuation of application No. 62/688,412, filed on Jun. 22, 2018.

(51) Int. Cl. C04B 35/64; C04B 35/111

(52) U.S. Cl. CPC C04B 35/64; C04B 35/563; C04B 35/111

(57) ABSTRACT

Disclosed is a method of flash sintering a sample composed of ceramic particles by providing laser energy to change the electrical properties of the ceramic material. The processes and systems disclosed herein do not require large heating equipment like a furnace allowing for a portable system of repairing ceramic materials in the field.

This application claims priority benefit of U.S. Provisional Patent Application Ser. No. 62/688,412 filed Jun. 22, 2018, entitled “LASER-ASSISTED FLASH SINTERING,” the complete disclosure of which, in its entirety is herein incorporated by reference.

### BACKGROUND

The present disclosure is directed toward methods and systems for densifying (sintering) ceramic green bodies composed of ceramic particles into a high-density composite in a short time frame. More particularly, the present disclosure is directed toward the utilization of a laser beam to alter the electrical properties of a selected region of a ceramic green body material while at least portion of the green body is subjected to an electrical field. The cooperative effect of the laser energy and current flow increases the density of the ceramic material.

Sintering of materials can be performed through a variety of methods. In general, denser ceramic bodies are produced by ‘sintering’ green powder compacts at high temperatures in a process that is traditionally both time and energy intensive. In the majority of traditional sintering methods for ceramics, a large amount of heat is applied to the green body for densification. It is most common for samples of material to be indirectly heated by convection or radiation, for example, from a resistance heating element, RF heated susceptor, or microwave heated susceptor. In other methods, samples are directly heated, i.e., the sample itself is the heat source. That is, samples directly absorb the energy from an electric current, RF field, microwave field or other methods of supplying energy to a shape. However, all the above-described approaches require that the sample be placed in a chamber and heated. For example, in microwave-induced sintering, the RF field heats the entire sample, in joule sintering, the sample is placed in a furnace and the temperature is raised and maintained for sintering to occur.

In traditional pressureless sintering, a sample remains in a heated furnace for prolong periods of time (hours to days). Hot pressing methods can reduce the sintering times to generally less than a day. Newer techniques such as Spark Plasma Sintering (SPS) also called field assisted sintering technology (FAST) and several other names can reduce the sintering time to 15-30 minutes. Flash sintering, on which the current disclosure is partially based, can reduce the sintering time to less than 2 minutes. All these techniques require equipment that is not easily portable.

Traditional flash sintering methods heat a sample of green body material in a furnace while under the influence of a constant (DC) electrical field. The electric field is used to decrease the activation energy for densification. Increasing the furnace temperature increases the kinetic energy of the ions/atoms in the sample. This, in turn, increases the mobility of the electrons in the sample eventually leading to the formation of a conduction path between a pair of applied electrodes. The addition of the electric field in flash sintering greatly decreases the temperature and time needed to densify material in a furnace, for example, the densification temperature may be reduced by about 200° C. or more. However, traditional flash sintering is limited in that a furnace is needed to heat an entire sample to its flash ignition point.

Often times, ceramic parts/components fail in the field requiring repair or replacement. Replacement of a ceramic part requires that an additional part be available, which is not always practical depending on the size and potential remote location of the failed part/component. To repair ceramic materials with the methods described above requires equipment that is generally not portable. Thus, it is desirable to densify ceramic materials without the need for large non-portable equipment, e.g., a furnace. It is also desirable to have portable systems and methods that enable the ability to repair broken/damaged ceramic components in the field. That is, the ability to promptly repair or fabricate a part in a remote location away from an industrial setting is desirable.

Additionally, the disclosed methods and systems can be used on opaque ceramic as well as transparent ceramic materials. The ceramics can also be mixtures of two or more phases. Another advantage is that the rapid processing time leads to no or very small grain growth in the sintered product thus, providing higher strength parts than larger grained conventionally sintered parts.

### INCORPORATION BY REFERENCE

U.S. Pat. No. 8,940,220 issued Jan. 27, 2015, to Raj et al. and entitled “METHODS OF FLASH SINTERING”; is incorporated herein by reference in its entirety.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

In accordance with some aspects of the present disclosure, described are exemplary methods for of sintering a green body composed of particles of ceramic material. The methods include providing a ceramic green body composed of ceramic particles, applying an electric field to the green body with a power supply and, illuminating a selected area of the green body with a laser beam emitted from a laser. The laser beam provides laser energy to the selected area of the green body and initiates densification of the selected area of the green body.

In accordance with other aspects of the present disclosure, described are exemplary methods of repairing a damaged area of ceramic body. The methods include providing particles of ceramic material to the damaged area and applying an electrical field across the damaged area with a power supply. The methods further include focusing a laser beam from a laser to provide laser energy to the damaged area while the damaged area is subject to the electrical field. The cooperative effect of the laser energy and electric field initiates densification of the particles of ceramic material.

In accordance with another aspect of the present disclosure, an exemplary system for sintering a ceramic green body is provided. The system includes at least two electrodes in a spaced apart relationship, wherein a space between the at least two electrodes is a selected area for sintering. The system also includes a power supply in electrical communication with the at least two spaced apart electrodes that is configured to apply an electric field to a green body. The system also includes a laser configured to emit a laser beam and at least one laser shaping element configured to shape a profile of the laser beam to illuminate the selected area for sintering, wherein simultaneous application of laser beam and electric field initiate densification in a ceramic green body.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic of the components of an exemplary system for laser-assisted flash sintering a ceramic green body in accordance with the present disclosure.

FIG. 2A is a drawing that illustrates an exemplary schematic of a green body in contact with a pair of electrodes and the conductivity and resistance measured along a selected line in accordance with the present disclosure.

FIG. 2B is a drawing that illustrates an exemplary schematic of a green body in contact with a pair of electrodes and the conductivity and resistance measured along a selected line that is illuminated with increasing laser power in accordance with the present disclosure.

FIG. 3 is a drawing that illustrates the effect on the density of ceramic particles before and after DC current is applied simultaneously with laser illumination.

FIG. 4 is a flow chart that illustrates an exemplary method of laser-assisted flash sintering a green body comprising particles of ceramic material is provided in accordance with the present disclosure.

FIG. 5 is a flow chart that illustrates an exemplary method of repairing a ceramic part with laser-assisted flash sintering in accordance with the present disclosure.

FIG. 6A is an image of a representative laboratory laser setup for laser-assisted flash sintering in accordance with the present disclosure.

FIG. 6B is an image of an exemplary green body sample attached to platinum electrodes with the aid of a silver contact in accordance with the present disclosure.

FIG. 6C is a thermal image of a laser beam line profile illuminating the green body sample of FIG. 6B.

FIG. 7 is an SEM micrograph of an aluminum oxide sample after laser-assisted flash sintering in accordance with the present disclosure.

FIG. 8 is an image of an exemplary boron carbide tape sample prior to laser-assisted flash sintering in accordance with the present disclosure.

FIG. 9 is an image of a shaped laser diode beam across the boron carbide tape sample of FIG. 8.

FIG. 10A is an SEM micrograph of the green body tape of FIG. 8 before laser-assisted flash sintering.

FIG. 10B is an SEM micrograph of the green body tape of FIG. 8 after laser-assisted flash sintering near the positive electrode.

FIG. 10C is an SEM micrograph of the green body tape of FIG. 8 after laser-assisted flash sintering near the negative electrode.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

As used herein, “ceramic materials” are defined as one or more metal cations chemically bonded to one or more non-metal anions. A ceramic is an inorganic compound, non-metallic, solid material comprising metal, non-metal or metalloid atoms primarily held in ionic and covalent bonds. Examples of ceramic materials include but are not limited to: LiF, B₄C, Al₂O₃, MgAl₂O₄, sesquioxides such as Lu₂O₃, Y₂O₃, Sc₂O₃, in addition to other metal oxides, and various garnets including YAG.

The term “green body” as used herein, is defined as a powder or collection of particles, aggregates, or mixtures thereof shaped into a weakly held free standing solid. The shape can be formed by dry pressing, casting, tape casting, cold isostatic pressing or other techniques. The powder can be shaped into a green body with or without the use of binders, plasticizers, or other additives.

As used herein, “sintering” is defined as the act of consolidating a green body into a dense shape. The green body being sintered must additionally not melt to a great extent, some melting of secondary phases in the powder, or surface melting is allowed under this definition. If the material completely melts, the process is referred to as fusion casting. Sintering, both pressureless and with pressure, or hot pressing, requires solid, liquid or gas material transport to consolidate an aggregate of loose powder particles into a dense shape. In the case of porcelain and clay products, secondary phases do melt and “glue” the primary solid particles together with a glassy phase. These types of systems were the first to be used due to their ease of sintering. However, advanced ceramics do not have these intrinsic sintering aids and they must, therefore, be added. For small samples, the powdered sintering aids are mixed with the powder to be sintered with a mortar and pestle. In larger samples, mixing is accomplished by ball milling, attritor milling, high shear wet milling, and variations or combinations of these methods. Dense ceramic bodies are traditionally produced by sintering green powder compacts at high temperatures. Sintering occurs by solid-state diffusion, which transports matter from grain boundaries into the neighboring pores.

Sintering aids are elements or chemical compound that enhance diffusion during densification. Sintering aids can react with the powder to cause diffusion or they can react with impurities on the powder surface to lower barriers against diffusion.

Photon energy E is defined by E=h c/A, where h is the plank constant, c is the speed of light and A. is the wavelength of light. The energy of the photon can be estimated in electron volts (eV) to be 1.2398/A, where A is assumed to be in micrometers.

The ionization energy is the energy required to remove an electron from the highest filled energy level into a free electron.

Semiconductor materials display an energy band gap, which is described as the energy required to excite an electron from the top of the valence band to the bottom of the conduction band. An electron excited to the conduction band is assumed to be able to move along the crystal.

Non-conductive polymers can display a similar energy barrier to the excitation of electrons from the highest occupied molecular orbital to the lowest unoccupied molecular orbital, where the electron can be free to span a wider spatial range or be further excited being the reach of the original molecule behaving as a free electron.

Heat, as used herein, is commonly understood as a manifestation of the movement of the atoms in a material, with collective excitations of modes in the material described by phonons.

As used herein, a “CW laser” is to be understood as a continuous wave laser. The CW laser emits a continuous, uninterrupted beam of light with a controlled heat output, beam duration and intensity.

As used herein a pulse laser (“PW laser”) is characterized by a laser pulse duration and a repetition rate at which the pulses are delivered. For a given volume V of material defined by density ρ, and thermal conductivity κ, and specific heat cv, the time it takes heat generated by the laser pulse to exit the volume can be estimated to be approximately t˜A ρ cv/κ, for example the time it takes for heat to leave a 1 μm diameter sphere in SiC is approximately 0.25 μs. The relation of the heat diffusion time to the inverse of the laser repetition rate can be used as a guide to determine whether heat delivered by a pulse will remain at the irradiated volume by the time the next pulse arrives.

The conductivity of induced free electrons can be estimated from the Drude model where the conductivity σ=n eτ/mₑ, with e, n, mₑ, and τ being the electron charge, number density of electrons, the effective mass, and mean free time between ionic collisions, respectively. As such increasing the number of free electrons increases the electrical conductivity.

In general, flash sintering is a technique or sintering materials in a very short time and lower temperature compared to other more traditional methods. The phenomenon of flash sintering is typically characterized by two experimental observations. The first experimental observation is that at a certain temperature and applied electrical field, there is a sudden increase in the sintering rate such that sintering occurs in the order of seconds. A higher applied field lowers the temperature for the onset of flash sintering. The second experimental observation is that the sintering event is accompanied by a sharp increase in the conductivity of the ceramic, which occurs at the same temperatures and applied field.

The present disclosure is significantly different from traditional flash sintering as there is no large furnace to provide heat and increase the mobility of the electrons. Instead, electrons are excited thermally using a CW laser or directly using a PW laser. Excited electrons can move under the presence of an electric field, or decay back into lower energetic states by scattering with phonons. In the latter case, some of the energy is dissipated as heat, raising the temperature of the material. In direct excitation methods, energy is directly coupled to the electrons of ceramic particles through the absorption of laser energy. In some embodiments, the photons of the laser beam do not interact with protons and neutrons instead, all the energy is directly coupled to the electrons. The methods described herein can therefore be implemented without the need to encapsulate the sample and/or without the need to control the outside atmosphere. The laser beam can be shaped to enable sintering of a localized region, i.e., not the whole sample. The distinct features of laser-assisted flash sintering greatly increase the portability of the equipment and allows repair or fabrication of parts away from an industrial setting, such as in a remote setting. The resulting sintered ceramic may have a smaller grain size than sintered ceramics produced with traditional furnace flash sintering methods providing higher strength parts.

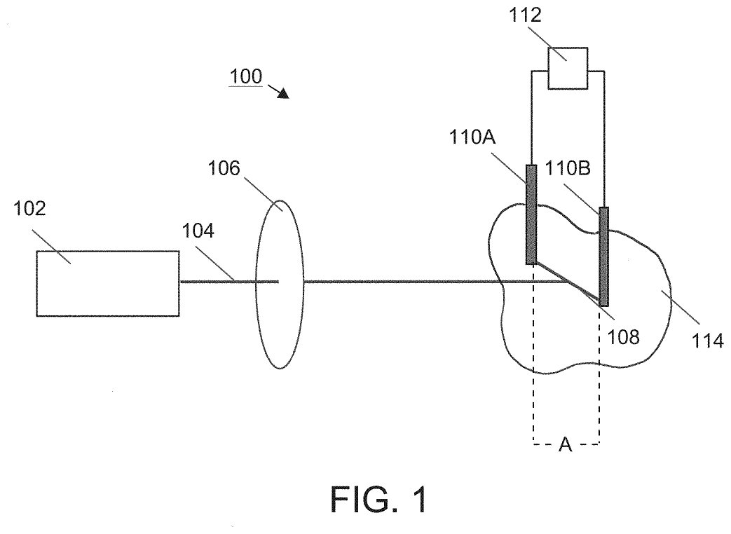

FIG. 1, depicts the components of an exemplary system for laser-assisted flash sintering in accordance with the present disclosure. The system 100 includes a laser 102 that is configured to generate a laser beam 104. The laser beam 104 is shaped by at least one beam shaping element 106, for example and without limitation, an optical lens, to illuminate a beam profile 108 in an area A between two-spaced apart electrodes 110A, 110B. The two-spaced apart electrodes 110A, 110B are in electrical connection with a power supply 112 and are configured to apply an electrical field to a selected portion of a ceramic green body 114.

The green body 114 is composed of ceramic particles of dimension from about 10 nm to about 200 μm. In preferred embodiments, the ceramic particles are from about 20 nm to about 100 μm. The green body 114 has a density of about 20% to about 70%. In some embodiments, the green body 114 is pressed into a desired mechanical shape before sintering. In other embodiments, the green body 114 includes binder materials and/or plasticizer to maintain the mechanical integrity. The green body 114 may be formed by dry pressing, casting, cold isostatic pressing, tape casting, or any other method commonly used to form green bodies by those skilled in the art. The ceramic materials may be oxide materials, non-oxide materials, or a combination of oxide and non-oxide materials.

The laser 102 provides a laser beam 104 in order to alter the electrical conductivity of the ceramic green body 114. The increase in conductivity is localized to the area of the laser profile 108 that impinges on the green body 114. That is, the laser beam 104 provides localized energy to activate electrons of the green body material 114 into the conduction band, allowing a high current to flow along the localized area of increased conductivity.

The laser may be embodied as a CW laser (continuous wave) or a PW (pulsed wave) laser. A laser includes but is not limited to diode laser, fibers, microchip lasers and the like.

The laser 102 emits a beam 104 of light having a particular wavelength. Laser light has an associated energy which can be transferred to the ceramic green body material. The laser type (CW, PW) is selected based upon a desired energy mechanism for activating electrons of the green body material to provide thermal energy to the material or directly couple energy to the electrons of the material.

In some embodiments, a CW laser is selected to heat up an area of the green body 114 that is illuminated by the laser beam 104. A CW laser may deliver energy to both the atomic nuclei and electrons of the green body material. The provided heat increases the kinetic energy of the ions/atoms in the sample, in turn increasing the mobility of the electrons of the green body material. The CW laser heats the illuminated area from tens (10s) to thousands (1000s) of degrees C. The CW laser is used to excite a large population of electrons directly into a conduction band and by proper choice of wavelength. In some embodiments, the wavelength of the CW laser light is selected to be within an absorption range of the ceramic material. That is, materials better absorb light energy and as a result, heat up when subject to wavelengths it readily absorbs. In some embodiments, the wavelength of the CW laser light is within the visible range. In other embodiments, the wavelength of the CW laser light is within the red and infrared range. In more particular embodiments, the wavelength of the CW laser is greater than 800 nm. In even more particular embodiments, the wavelength of the CW laser is from about 900 nm to about 15 μm, including about 976 nm and about 10.6 μm.

In some embodiments, a PW laser is selected to directly couple energy to the electrons of a ceramic material through their absorption of laser light. PW lasers are used to nonlinearly excite a large population of electrons from their non-conducive valence band into a conduction band while producing a minimal amount of heat. Thus, components that may be underlying the ceramic material will less likely be subjected to potentially damaging heat during sintering. Photons do not interact with protons and neutrons, instead all the energy from the laser is directly coupled to the electrons of the targeted material. PW lasers provide little heat to the same because the repetition rate of the laser can be lower than the inverse of the heat diffusion time, and therefore no heat is accumulated from one pulse to the other. Generally, the pulsed laser induces less than a 100° C. temperature rise to the sample.

The power supply 112 of the system is configured to generate an electric field in the ceramic green body 114. The power supply 112 is in electronic communication with at least two electrodes 110A and 110B. The electrodes 110A and 110B are spaced apart and placed in contact with the green body 114. In some embodiments, the electrodes 110A 110B are composed of platinum, although other conducting materials may be used. The electrodes are generally spaced apart from about 1 mm to about 5 cm. In preferred embodiments, the electrodes 110A 110B are spaced apart from about 1 cm to about 3 cm. However, the spaced apart placement of the electrodes is not limiting, rather the spacing of the electrodes 110A, 110B is dependent on the power of the laser and its ability to excite the green body material along the spaced apart area.

In some embodiments, the power supply 112 is a direct current (DC) power supply. The DC power supply is configured to supply from about 10 V to about 5000 V to the green body 114. The voltage supplied generates an electric field across the spaced apart region A from about 100V/cm to about 2000V/cm. In some preferred embodiments, the power supply 112 generates a potential of about 1500V/cm. In other embodiments, the power supply generates a potential of about 50V/cm to about 400V/cm. It is to be understood that the exemplary embodiments disclosed herein as using a direct current power supply are non-limiting, i.e., other power supplies including alternating current (AC) power supplies may be used.

When the laser beam power is sufficient to heat and excite a large enough carrier density, a current can flow through the green body 114 between the spaced apart electrodes 110A, 110B. The current is driven by the electrical power supply 112 for a fixed time duration of less than about an hour. In preferred embodiments, the current is controlled to flow for less than about 30 minutes. In more preferred embodiments, the current is controlled to flow for less than about 2 minutes. After the current is removed, the density of the area of the green body 114 exposed to the electric field and laser light has increased to over 80%, and more preferably over 99%.

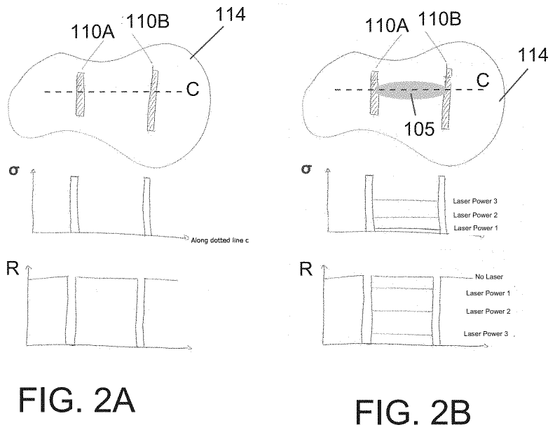

FIGS. 2A and 2B are schematics of a field-induced laser sintering process in accordance with the present disclosure. In FIGS. 2A and 2B, electrodes 110A and 110B are placed on green body 114. The conductivity σ and resistivity R along the line C are each illustrated graphically. As shown in FIG. 2A, with no laser illumination present, the conductivity between the electrodes is low. In FIG. 2B, laser illumination 105 between electrodes 110A-B causes an increase in conductivity σ and a decrease in resistance R as laser power is increased.

The shape of the sintered area A can be controlled by changing the shape and placement of the electrodes and/or by changing the area illuminated by the laser. FIG. 2B shows how the sintered area is controlled by the electrodes. That is, there is no conductivity outside the area between the two electrodes. It should be noted that both the linear potential of the electric field between the two electrodes 110A 110B and the laser power delivered to the material should be maintained constant.

The shape of the laser beam (beam profile 108) is controlled by at least one shaping element 106. That is, the circular or elliptical shape of the laser beam 104 cross-section generally produced by a laser, may be changed by at least one shaping element 106. In some embodiments, the at least one shaping element 106 includes at least one optical lens including but not limited to spherical lenses, aspherical lenses, cylindrical lenses, and the like. The at least one shaping element 106 is configured so that laser light simultaneously illuminates an entire linear length between the spaced apart electrodes 110. In preferred embodiments, the at least shaping element 106 is a cylindrical lens that focuses the laser beam to a line profile 108 illustrated in FIG. 1. In these embodiments, the length of the laser line beam profile 108 is adjusted to match the spacing of the spaced apart electrodes. Since only the portion of the green body that is both between the electrodes and illuminated by the laser will flash sinter, the area A of the green body 114 being sintered can be controlled.

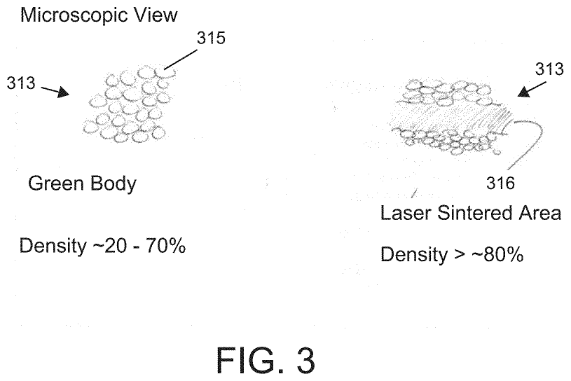

FIG. 3 illustrates the effect on the density of ceramic particles 315 before and after the laser and DC current are applied. The density of the green body 313 shows an increase over the affected area 316, reaching at density over about 80%.

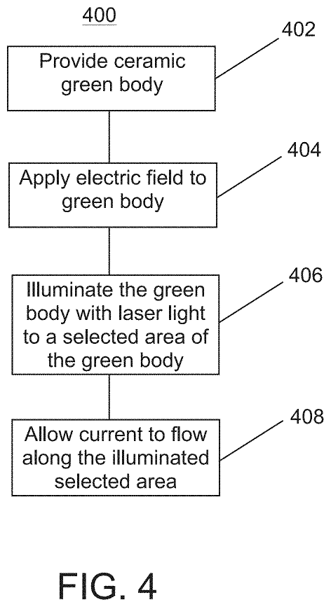

In accordance with another aspect of the present disclosure and with reference to FIG. 4, an exemplary method 400 of sintering a green body comprising particles of ceramic material is provided. The method 400 includes providing a green body of ceramic material, subjecting the green body to an electric field and illuminating a portion of the green body with laser light to initiate densification.

At block 402, a ceramic green body is provided. A ceramic green body is composed of powder or collection of particles, aggregates, or mixtures thereof shaped into a weakly held free standing solid. The shape of the free-standing solid can be formed by dry pressing, casting, tape casting, cold isostatic pressing or other techniques. In some embodiments, additional components such as binder and plasticizers may be added to the ceramic green body for supporting and maintaining the solid shape. In some embodiments, the green body has a density between about 20% to about 70%.

At block 404, the green body, or a portion of the green body is subjected to an electric field. The electric field is produced by a power supply, such as power supply 112 of FIG. 1 and applied to the green body via at least one electrode. In some embodiments, a pair of electrodes are placed in contact with or in close proximity to an exposed surface of the green body/portion of the green body. The electrodes are selectively placed in a spaced apart relationship to each other applied electrode. The spacing between the electrodes is dependent on the power of an applied laser and power capability of the power supply. In some embodiments, the power supply is a DC power supply configured to apply from about 10V to about 5000 V to the green body, producing an electric field from about 50 V/Cm to about 2000V/cm.

At block 406, a portion of the green body is illuminated with laser light from a laser. The laser light is shaped by a shaping element (such as previously described shaping element 106 of FIG. 1) to illuminate a portion between each of the electrodes that are in contact with or in close proximity to the green body. As described above, the laser beam of the laser provides laser energy to the selected area of the green body. The localized energy initiates electrons of the green body to flow and induce a current. The laser may be a CW laser or a PW laser. The wavelength of the beam emitted by the laser may be selected to match an absorbance of the green body material. In other embodiments, the wavelength may not be within the absorbance band of the material, but the power of the laser is significant enough to heat the illuminated portion of the green body. In some embodiments, the wavelength is in the red, near infrared, or infrared portion of the electromagnetic spectrum. In other embodiments, the wavelength is selected to directly couple energy to electrons of the green body material while providing little to no heat to the sample, e.g., the wavelength is shorter than about 500 nm.

At block 408, current is allowed to flow between the electrodes and through the selected area of the green body to promote densification. The current flow is accompanied by a flash signaling densification of the green body in the selected area. The selected area is sintered having a density of greater than 80% and preferably greater than 90%, and more preferably greater than 99%.

In some embodiments, at block 408, the current, driven by the electrical power supply, such as power supply 112, is allowed to flow for a fixed time duration of less than about an hour. In preferred embodiments, current is controlled to flow for less than about 30 minutes. In more preferred embodiments, current is controlled to flow for less than about 2 minutes, includes less than one minute, less than 30 seconds, and less than 15 seconds.

Current flow at block 408 is generally less than about 1.0 amp. In some embodiments, the current flow is less than 0.5 amp. In preferred embodiments, the current flow is less than 0.1 amp including about 0.05 amp.

It is to be appreciated that the above method does not require that the entire sample be heated, for example, in a furnace. The method does not require a controlled atmosphere, nor flowing of a gas, however, the method does allow for flowing of a gas such as an inert gas or an oxidation gas and can be performed within a controlled atmosphere.

It is further contemplated that flash sintering may occur with the laser alone, however, sintering would occur at a higher temperature than when subjected to an electric field. That is, the application of the electric field reduces the temperature required to produce sintering in the material, in some instances the reduction in temperature compared to flash sintering without an electric field is about 200° C. to 1500° C. To achieve the higher temperatures when no electric field is present, a non-portable laser would be required.

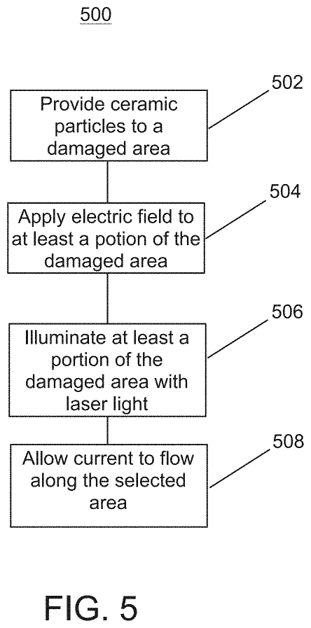

In accordance with another aspect of the present disclosure and with reference to FIG. 5, a method 500 for repairing a damaged ceramic material is provided.

At block 502, a ceramic green body is material is provided to a damaged area. Ceramic green body material is composed of powder or collection of particles, aggregates, or mixtures thereof. In some embodiments, ceramic powder is applied to the damaged area, for example, used to fill in a crack in a damaged ceramic part. In other embodiments, the green body is a tape cast material. The green tape is traditionally made by combining ceramic powder, a liquid dispersion agent (such as water or alcohol), binders and plasticizers to form a stable slurry. The slurry is thinly spread on a non-adhesive flat surface using a film coating technique such as doctor blade and roller blade technique to create a tape 10-500 μm thick. Slowly drying the tape under proper humidity creates a green tape that is easily handled, bent, folded, cut and stacked as needed. In these embodiments, the green body tape is applied to the damaged surface. In some embodiments, additional material such as binder and plasticizers may be added to the ceramic green body for supporting and maintaining the solid shape. In some embodiments, the green body has a density between about 20% to about 70%.

At block 504, the ceramic particles or green body tape, or a portion thereof, used to repair the damaged area is subjected to an electric field. The electric field is produced by a power supply, such as power supply 112 of FIG. 1, and applied to the repair area via at least one electrode. In some embodiments, a pair of electrodes are placed in contact with or in close proximity to an exposed surface of the damaged area with applied ceramic particles/green body tape. The electrodes are selectively placed in a spaced apart relationship to each other applied electrode. The spacing between the electrodes is dependent on the power of an applied laser and power capability of the power supply. In some embodiments, the power supply is a DC power supply configured to apply from about 10V to about 5000 V to the green body. In some embodiments, the DC power supply provides an electric field from about 50V/cm to about 2000V/cm. In more particular embodiments, the DC power supply provides an electric field of about 100V/cm to about 400V/cm. In other preferred embodiments, the DC power supply provides an electric field of about 400V/cm to about 1600V/cm, including about 1500V/cm.

At block 506, a portion of the damaged area with applied ceramic particles is illuminated with laser light from a laser. The laser beam is shaped with a beam shaping element to illuminate a portion of the green body between each of the electrodes that are in contact with or in close proximity to the damaged area. As described above, the laser beam of the laser provides laser energy to the selected area of the body. The localized energy initiates electrons of the green body material to flow and induce a current. The laser may be a CW laser or a PW laser. The wavelength of the beam emitted by the laser may be selected to match an absorbance of the green body material. In other embodiments, the wavelength may not be within the absorbance band of the material, but the power of the laser may be significant enough to heat an illuminated portion of the green body. In some embodiments, the wavelength is in the red, near infrared, or infrared portion of the electromagnetic spectrum. In other embodiments, the wavelength is selected to directly couple energy to electrons of the green body material while providing little to no heat to the sample.

At block 508, current is allowed to flow between the electrodes and through the selected damaged area with ceramic particles/green body tape to promote densification. The current flow is accompanied by a flash signaling densification of the green body in the selected area. The selected area is sintered having a density of greater than 80% and preferably greater than 90%, and more preferably greater than 99%.

The present disclosure is further illustrated in the following non-limiting working examples, it is being understood that these examples are intended to be illustrative only and that the disclosure is not intended to be limited to the materials, conditions, process parameters and the like recited herein.

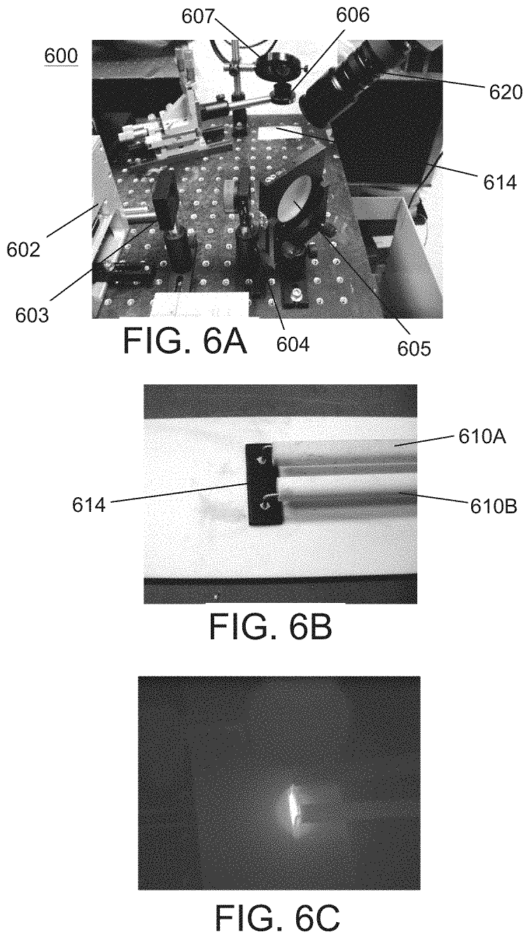

FIG. 6A is a photograph of a representative laboratory laser setup 600 for laser-assisted flash sintering as performed in the examples below. The setup 600 includes a laser 602 and a plurality of optical elements to direct a laser beam. The optical elements included are: ball lens 603, re-collimating lens 604, a first mirror 605, cylindrical lens 606, and a second mirror 607. The setup 600 also includes green body sample 614 and a camera 620 for capturing images. FIG. 6B shows the green body sample 614 attached to platinum electrodes 610A, 610B with the aid of a silver contact. FIG. 6C is a thermal image of a line laser beam line profile illuminating the green body sample.

### EXAMPLES

### Example 1

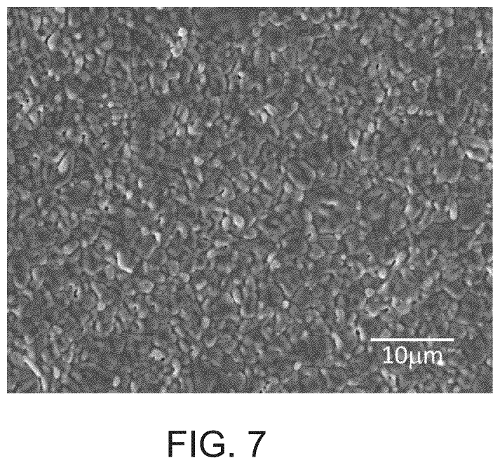

An alumina green body sample was formed from 100 nm particles and compressed into a 25 mm diameter by 2 mm disk shaped green body. Two contact holes were drilled into the resulting disk. A platinum electrode was inserted into the contact holes and connected to a direct current power supply. The power supply was set to 3000 V, inducing a field of 1500 V/cm. The optical field of a continuous wave diode later at 976 nm capable of 100 W was beam shaped to a line to span the distance between the electrodes. The sample was illuminated by the laser for a period of approximately 2 minutes and the conductivity of the sample increased allowing the direct current supply to flow 0.05 amps across the electrodes. After about one minute, the current was turned off. The region excited by the current displayed increased densification increasing from approximately 40% to 99+%. FIG. 7 is an SEM micrograph of an aluminum oxide sample after laser-assisted flash sintering. It is noted, that 976 nm is not within an absorption band of alumina.

### Example 2

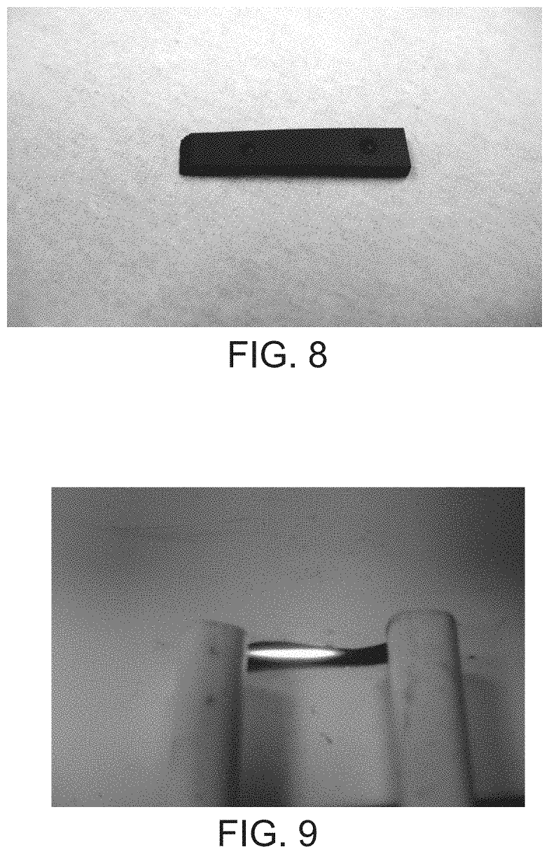

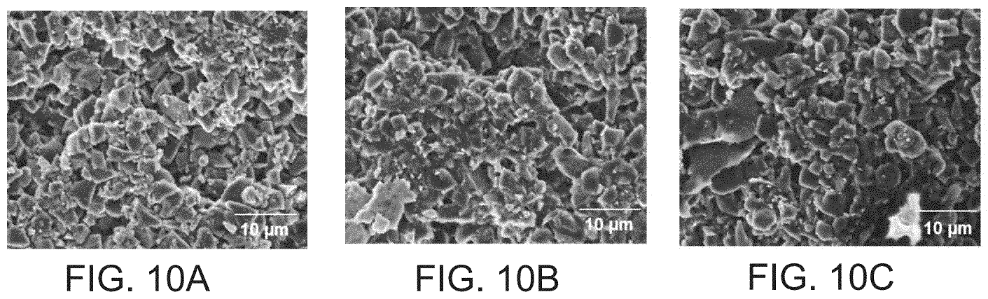

A B₄C green body was formed by tape casting and stacking green tapes. That is, 3 μm power was mixed with a binder and case into 60 μm thick green body tape. Layers of green body tape were stacked, cut and pressed into 4 cm by 1 cm×1.20 mm thick green bodies. Two electrodes were painted onto the surface of the sample with silver paste and contacted to platinum electrodes. The electrodes were connected to a direct current power supply. The power supply was set to 200 V, inducing a field of 100 V/cm. The optical field of a continuous wave diode laser at 976 nm, capable of a maximum of 100 W, was beam shaped to span the distance between the electrodes. The sample was illuminated by the laser for approximately 2 minutes and the conductivity of the sample increased allowing the direct current supply to flow 0.05 amp across the electrodes. After about one minute the current was turned off. The region excited by the current displayed increased densification increasing from approximately 40% to 99+%. FIG. 8 is the boron carbide sample prior to laser-assisted flash sintering. The divots in the sample are to provide better electrical contact with the electrodes. FIG. 9 illustrates the shaped laser diode beam across a boron carbide sample. FIGS. 10A-C illustrate SEM micrographs of the green body tape before the flash (FIG. 10A) and after the flash both near the positive electrode (FIG. 10B) and near the negative electrode (FIG. 10C). The SEM micrographs of FIGS. 10B-C show evidence of necking and sintering. Areas near the negative electrode show exaggerated grain growth.

### Example 3

A non-conductive ceramic green body was formed by tape casting. The average particle size was about 200 nm. The sample was formed into a thin film and spread across a surface. Two electrodes were painted onto the surface of the sample with silver paste and contacted to platinum electrodes. The electrodes were connected to a direct current power supply. The power supply was capable of a maximum of 4000 V and was to about 3000 V, inducing a field of 1500 V/cm. An optical field from a pulsed laser with a repetition rate of 1 kHz and a pulse duration of 10 ps was beam shaped to span the distance between the electrodes. Exposure of the sample to less than 1 second illumination of the laser lead to increased conductivity and current flowing from one electrode to another. The current was limited to about 50 mA and allowed to continue for about one minute. The region excited by the current displayed increased densification increasing from approximately 40% to 99+%.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art, which are also intended to be encompassed by the following claims.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1) A method of sintering a body comprising particles of ceramic material, the method comprising:
providing a ceramic green body composed of ceramic particles;
applying an electric field to the green body with a power supply; and,
illuminating a selected area of the green body with a laser beam emitted from a laser, wherein the laser beam provides laser energy to the selected area of the green body to initiate densification of the selected area.

2) The method according to claim 1, wherein the laser is a continuous wave laser.

3) The method according to claim 2, wherein a wavelength of the laser beam is longer than 800 nm.

4) The method according to claim 2, wherein a wavelength of the laser beam is from about 900 nm to about 1100 nm.

5) The method according to claim 1, wherein the laser is a pulsed laser.

6) The method according to claim 5, wherein a wavelength of the laser beam is shorter than 500 nm.

7) The method according to claim 1, wherein the selected area of the green body is sintered in a time less than 2 minutes from the application of laser energy.

8) The method according to claim 1, wherein the electric field is generated by application of an electric voltage via two spaced-apart electrically conductive electrodes, wherein the electrically conductive electrodes are in electric communication with the power supply.

9) The method according to claim 8, wherein the selected area of the green body is located between the two spaced apart electrically conductive electrodes.

10) The method according to claim 8, wherein the laser beam is focused to illuminate an area between the two spaced apart electrically conductive electrodes.

11) The method according to claim 1, wherein the laser beam has a line profile.

12) The method according to claim 1, wherein the particles of ceramic material are in the form of a powder.

13) The method according to claim 1, wherein the particles of ceramic material are applied in the form of a cast tape.

14) The method according to claim 1, wherein the densification of the selected area results in an increase in density of the ceramic green body from about less than 70% to greater than 80%.

15) The method according to claim 1, wherein a wavelength of the laser beam is within an absorption band of the ceramic material.

16) A method of repairing a damaged area of ceramic body comprising:
providing particles of ceramic material to the damaged area;
applying an electrical field across the damaged area with a power supply; and,
focusing a laser beam from a laser to provide laser energy to the damaged area while the damaged area is subject to the electrical field to initiate densification of the particles of ceramic material.

17) The method according to claim 15, wherein the laser is a continuous wave laser and the laser beam has a wavelength longer than 800 nm.

18) The method according to claim 15, wherein the laser is a pulsed wave laser and an emitted laser beam has a wavelength shorter than 500 nm.

19) The method according to claim 15, wherein the electric field is generated by application of an electric voltage via two spaced-apart electrically conductive electrodes, wherein the electrically conductive electrodes are in electric communication with the power supply.

20) A system for sintering a ceramic green body comprising:
at least two electrodes in a spaced apart relationship, wherein the space between the at least two electrodes is a selected area for sintering;
a power supply in electrical communication with the at least two spaced apart electrodes configured to apply an electric field to at least a portion of a ceramic green body;
a laser providing a laser beam; and,
at least one laser shaping element configured to shape the laser beam profile to illuminate the selected area for sintering, wherein simultaneous application of laser beam and electric field initiate densification in a ceramic green body.

21) The system according to claim 20, wherein the power supply is configured to apply from about 100 V to about 5000 V of electrical potential or a flow of current from about 1 mA to about 100 A through the selected area for sintering;

22) The system according to claim 20, wherein the laser is one of a continuous wave laser emitting the laser beam with wavelength longer than 800 nm and a pulsed wave laser emitting the laser beam with a wavelength shorter than 500 nm.

23) The system according to claim 20, wherein a wavelength of the laser beam is within an absorption band of the ceramic material.
